(19) United States
(12) Patent Application Publication
(10) Pub. No.: US 2025/0227638 A1
(43) Pub. Date: Jul. 10, 2025

(54) PLANNED CONFIGURATIONS IN RADIO COMMUNICATION SYSTEMS

(71) Applicant: TOYOTA JIDOSHA KABUSHIKI KAISHA, Toyota-shi (JP)

(72) Inventors: Kai-Erik SUNELL, Naantali (FI); Takayuki SHIMIZU, Mountain View, CA (US); Claude ARZELIER, Varna (BG); Nuno KIILERICH PRATAS, Gistrup (DK)

(73) Assignee: TOYOTA JIDOSHA KABUSHIKI KAISHA, Toyota-shi (JP)

(21) Appl. No.: 19/096,586

(22) Filed: Mar. 31, 2025

Related U.S. Application Data
(63) Continuation of application No. PCT/JP2023/031380, filed on Aug. 30, 2023.

(51) Int. Cl. H04W 56/00; H04W 64/00; H04W 84/06

(52) U.S. Cl. CPC H04W 56/0015; H04W 64/00; H04W 84/06

(57) ABSTRACT

Disclosed are methods, apparatuses, and systems for applying configuration information for use in a node. A method includes determining current information. In the node, one or more sets of criteria and configuration information corresponding to each criterion are accessed. The current information is compared with the sets of criteria. On a condition that the current information matches at least one criterion of the sets of criteria, the configuration information corresponding to the matching at least one criterion is applied for use in the node.

### CROSS-REFERENCE TO RELATED APPLICATIONS

This application claims the benefit of priority of U.S. Provisional Patent Application No. 63/377,590, filed on Sep. 29, 2022, the entirety of which is incorporated by reference herein.

### TECHNICAL FIELD

This disclosure relates generally to communications, more specifically, to methods, systems, and devices for planned configurations in radio communication systems.

### BACKGROUND

Multi-user radio and telecommunication systems may suffer from scarcity of communication resources. Therefore, radio communication systems make use of geographical reuse of spectrum resources. In the context of terrestrial mobile communication systems, the solution is generally referred to as the cellular concept, but the same principle may also be applied to other systems such as satellite systems, ad hoc networks, radio broadcasting systems, and direct communication between transceivers such as peer-to-peer communication systems.

Spectrum reuse may facilitate efficient use of scarce resources, but it may give rise to complex resource allocation problems due to mutual interference caused by potential contamination of an information-bearing signal by the presence of another similar kind of signal at the receiving antenna.

In mobile communication systems, radio resource control and medium access control protocols may resolve some of those issues. If the network has a signaling connection with user equipment, radio resources are configured and subsequently reconfigured depending on time-varying interference and traffic conditions. If user equipment is in an idle state and thereby temporarily unreachable by controlling network entities with a signaling connection, broadcasted system information configures the resources, e.g., for random access, synchronization, and paging. System information is further reacquired at regular intervals and upon cell reselections.

A more challenging scenario may occur if devices cannot receive network signaling prior to access to the communication medium, if such configurations would be too difficult and/or costly to provide, or if network infrastructures are not used/needed. In such cases, pre-configurations may be employed. Pre-configurations may be stored or hard coded in the equipment software, or provided, for example, in a Universal Integrated Circuit Card (UICC). A similar issue may arise within network nodes, which cannot necessarily benefit from operation and maintenance at specific times.

3rd Generation Partnership Project (3GPP) technologies may take advantage of pre-configurations in many use cases as described in the 3GPP technical specifications and exemplified as follows:
(1) Uplink resources may be pre-configured for machine-to-machine type communication devices.
(2) Home base stations have pre-configured information for infrastructure connections.
(3) Relay nodes may be pre-configured with information regarding cells they are allowed to access.
(4) 5G Quality of service (QOS) parameters may be pre-configured in user equipment (UE).
(5) The UE may be pre-configured with information about differentiated handling of traffic for different networks in network slicing deployments.
(6) The UE may use pre-configured information for relay node discovery.
(7) Mapping of cell identities in 3GPP non-terrestrial communication may be based on pre-configured information in the UE.
(8) Public safety and mission critical push-to-talk devices may use pre-configured communication and synchronization resources.
(9) Sidelink communication devices and proximity services may be pre-configured for out-of-coverage autonomous resource selection, and may use pre-configured priority thresholds as well as pre-configured radio parameters for discontinuous reception, for example.
(10) 3GPP Technical Specification (TS) 31.102 uses information stored in the Universal Subscriber Identity Module (USIM), and may apply for universal mobile telecommunications service (UMTS), long-term evolution (LTE), and/or fifth-generation (5G). This information may be updated, for example, via a subscriber identification module (SIM)/USIM toolkit by the home Public Land Mobile Network (PLMN). This information may be used, for example, for operations as diverse as security, network selection, or information to the user for cost of calls. It is noted that other examples than TS 31.102 may be possible for USIM information.
(11) Information may be received by the UE via non-access stratum (NAS) messages, for example, by use of 3GPP TS 24.301 for LTE or 3GPP TS 25.401 for 5G.

### SUMMARY

In some embodiments, a method for applying configuration information for use in a node is provided. The method includes determining current information. In the node, one or more sets of criteria and configuration information corresponding to each criterion are accessed. The current information is compared with the one or more sets of criteria. On a condition that the current information matches at least one criterion of the one or more sets of criteria, the configuration information corresponding to the matching at least one criterion is applied for use in the node.

In some embodiments, a node for applying configuration information for use in the node is provided. The node includes a memory configured to store instructions and a processor configured to execute the instructions stored in the memory to: determine current information; access, in the node, one or more sets of criteria and configuration information corresponding to each criterion; compare the current information with the one or more sets of criteria; and on a condition that the current information matches at least one criterion of the one or more sets of criteria, apply the configuration information corresponding to the matching at least one criterion for use in the node.

In some embodiments, a non-transitory computer-readable medium storing instructions that are executable by one or more processors of a node in a communication network to perform a method is provided. The method includes determining current information. In the node, one or more sets of criteria and configuration information corresponding to each criterion are accessed. The current information is compared with the one or more sets of criteria. On a condition that the current information matches at least one criterion of the one or more sets of criteria, the configuration information corresponding to the matching at least one criterion is applied for use in the node.

The above and other aspects and their implementations are described in greater detail in the following descriptions and in the drawings.

### BRIEF DESCRIPTION OF DRAWINGS

FIG. 1 is a block diagram of a node, consistent with some embodiments of the present disclosure.

FIG. 2 is a flowchart of a method for applying configuration information for use in a node, consistent with some embodiments of the present disclosure.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses, systems, and methods consistent with aspects related to subject matter that may be recited in the appended claims.

In some embodiments, the disclosed methods, systems, apparatuses, and devices are related to configurations in radio and telecommunication systems in general and to address, but are not limited to, configuration use cases (such as the pre-configuration use cases) as exemplified above for a set of so far standardized 3GPP functionalities, architectures, and features.

Configurations may be difficult and slow to change, and may be especially complicated when they need to be changed for a large user population at the same time. Also, it may be difficult to ensure that all devices have updated or changed their configurations. At least some of the disclosed embodiments may mitigate or eliminate the above-noted difficulties.

In some embodiments, if a configuration is stored in a device (e.g., a node), it may be changed or updated by infrastructure nodes, e.g., prior to accessing the communication medium. Successful updating of configuration information may involve having all devices subscribe to an operator service, stay within network coverage, and either acquire system information or set up signaling connections frequently with infrastructure nodes.

In some embodiments, if configuration information is provided in a UICC or in a SIM, the end-user or service personnel may update or change the card. Successful changing or updating of configuration information may involve having all cards changed or updated in all deployed devices that are using the configuration information.

As used herein, the term “configuration information” may include information that is stored in a node (for example, in a memory of the node, in a SIM card, or in a similar device), and also information received by the node from a communications network (for example, pre-configuration information as understood under the 3GPP standards).

As used herein, the term “node” may include a network node (e.g., an evolved Node B (eNB) or a 5G Node B (gNB)), a roadside unit (RSU), a relay node, a user equipment (UE), or a mobile equipment (ME). In an embodiment, the node may be configured to communicate using sidelink communication.

### Node

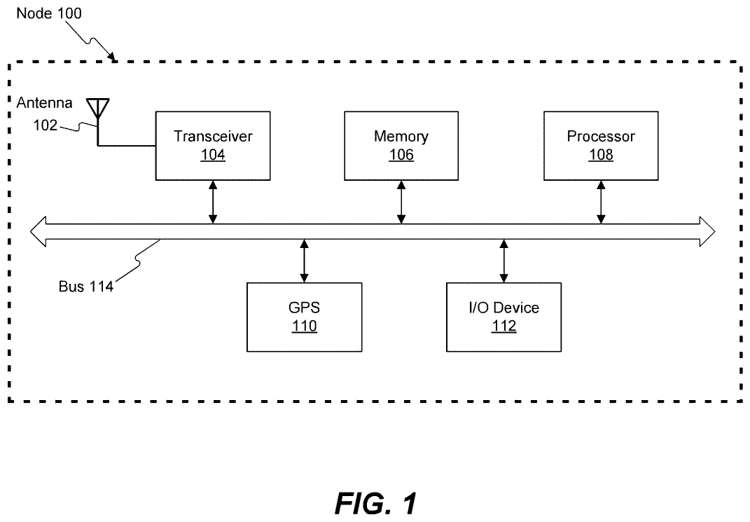

FIG. 1 is a block diagram of a node 100, consistent with some embodiments of the present disclosure. The node 100 may be mounted in a moving vehicle, in a fixed position (e.g., as a roadside unit (RSU)), or may be mobile device (e.g., as a UE), such as carried by a person. The node 100 may take any form, including but not limited to, a vehicle, a component mounted in a vehicle, an RSU, a laptop computer, a wireless terminal including a mobile phone, a wireless handheld device, a wireless personal device, or any other form. Referring to FIG. 1, the node 100 may include an antenna 102 that may be used for transmission and/or reception of electromagnetic signals to/from a base station or other nodes. The antenna 102 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 102 may include multiple (e.g., tens or hundreds) antenna elements and may enable multi-antenna functions such as beamforming. In some embodiments, the antenna 102 is a single antenna.

The node 100 may include a transceiver 104 that is coupled to the antenna 102. The transceiver 104 may be a wireless transceiver at the node 100 and may communicate bi-directionally with a base station or other nodes. For example, the transceiver 104 may receive wireless signals from a base station via downlink and transmit wireless signals to the base station via uplink communication. The transceiver 104 may also receive wireless signals from, and transmit wireless signals to another node, such as a UE or RSU via sidelink communication. The transceiver 104 may include a modem to modulate the packets and provide the modulated packets to the antenna 102 for transmission, and to demodulate packets received from the antenna 102.

The node 100 may include a memory 106. The memory 106 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

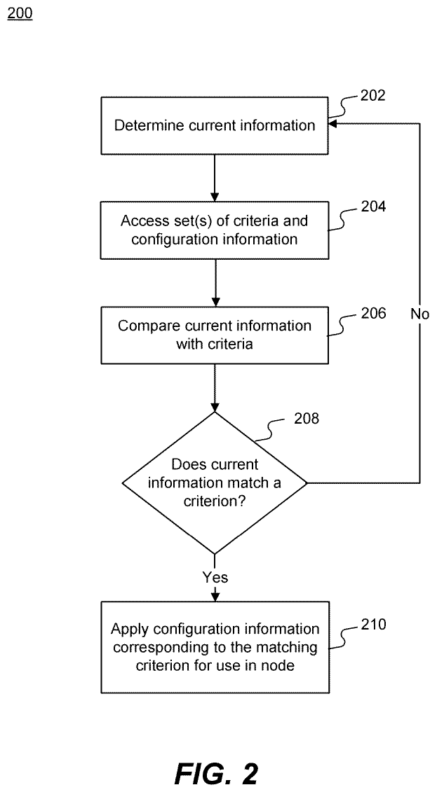

The memory 106 may store information related to identities of the node 100 and the signals and/or data received by the antenna 102. The memory 106 may also store post-processing signals and/or data. The memory 106 may also store computer-readable program instructions, mathematical models, and algorithms that are used in signal processing in transceiver 104 and computations in a processor 108. The memory 106 may further store computer-readable program instructions for execution by the processor 108 to operate node 100 to perform various functions described elsewhere in this disclosure, such as the method 200 shown in the flowchart of FIG. 2. In some examples, the memory 106 may include a basic input/output system (BIOS) which may control basic hardware or software operation such as the interaction with peripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The node 100 may include the processor 108 that may include a hardware device with processing capabilities. The processor 108 may include at least one of a general-purpose processor, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 108 may be implemented using a combination of devices (e.g., a combination of a DSP and a microprocessor, multiple microprocessors, one or more microprocessors in conjunction with a DSP core, or any other such configuration). The processor 108 may receive downlink signals or sidelink signals from the transceiver 104 and further process the signals. The processor 108 may also receive data packets from the transceiver 104 and further process the packets. In some embodiments, the processor 108 may be configured to operate a memory using a memory controller. In some embodiments, the memory controller may be integrated into the processor 108. The processor 108 may be configured to execute computer-readable instructions stored in a memory (e.g., the memory 106) to cause the node 100 to perform various functions.

The node 100 may include a global positioning system (GPS) 110. The GPS 110 may be used for enabling location-based services or other services based on a geographical position of the node 100 and/or for synchronization among nodes. The GPS 110 may receive global navigation satellite systems (GNSS) signals from a single satellite or a plurality of satellite signals via the antenna 102 and provide a geographical position of the node 100 (e.g., coordinates of the node 100). In some embodiments, the GPS 110 may be omitted.

The node 100 may include an input/output (I/O) device 112 that may be used to communicate a result of signal processing and computation to a user or another device. The I/O device 112 may include a user interface including a display and an input device to transmit a user command to the processor 108. The display may be configured to display a status of signal reception at the node 100, the data stored at the memory 106, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The node 100 may further include a machine interface 114, such as an electrical bus that connects the transceiver 104, the memory 106, the processor 108, the GPS 110, and the I/O device 112.

In some embodiments, the node 100 may be configured or programmed for sidelink communications. The processor 108 may be configured to execute the instructions stored in the memory 106 to perform a method for applying configuration information for use by the node 100, such as the method 200 described in connection with FIG. 2. The processor 108 may be configured or programmed to execute the instructions stored in the memory 106 to determine current information; access, in the node (e.g., memory 106), one or more sets of criteria and configuration information corresponding to each criterion; compare the current information with the one or more sets of criteria; and on a condition that the current information matches at least one criterion of the one or more sets of criteria, apply the configuration information corresponding to the matching at least one criterion for use in the node 100.

### Applying Configuration Information

In some embodiments, if configuration information is provided in a UICC or in a SIM, the end-user or service personnel may update or change the card. Successful changing or updating of the configuration information may involve having all cards changed or updated in all deployed devices that are using the configuration information. In an embodiment where the node communicates using sidelink information, there may be no controlling entity to direct or instruct the node to use a particular frequency, for example. When there is no controlling entity, the node may rely on configuration information to be able to communicate.

In some embodiments, configuration information may be successfully and reliably changed to a large population of devices at the same time, even if devices are out-of-coverage in a radio system, without setting up two-way signaling connections and context with network infrastructure entities, without registering devices to a telecom operator service, without requiring software or hardware (e.g., a UICC or SIM card) upgrades, or without recurrent operation and maintenance operations for network infrastructure entities.

At least some embodiments are directed to methods, systems, apparatuses, and devices for changing and updating configuration information in different types of equipment and infrastructure nodes in radio and telecommunication systems. Herein, these equipment and infrastructure nodes are denoted as “nodes” as a generic term referring to end-user equipment (e.g., UE, ME), routers, gateways, repeaters, relay nodes, satellites, roadside units, vehicle mounted modules, modems, and network infrastructure nodes, such as base stations, controllers, access points, and sub-systems thereof.

In at least some embodiments, the disclosed methods, systems, apparatuses, and devices may use a data structure that conveys a set of configuration information together with validity criterion. In some embodiments, the data structure may be a table-like data construct with one or several contents, e.g., rows. An example of an implementation of such a data structure is a list with multiple instances or objects. Each content or row may include one or more configurations. One or several validity criteria (e.g., columns) may be associated with the corresponding configuration information.

The configurations may be, e.g., uplink radio resources for machine-to-machine type communication, communication and synchronization resources for public safety communication, radio resource pools and bandwidth allocations for sidelink communication, Quality of Service (QOS) parameters, or configured radio parameters for discontinuous reception in sidelink group communication, for example.

The node may evaluate associated validity criterion/criteria (e.g., columns) associated with one or more configurations (e.g., on one or more rows), e.g., scanning them one-by-one starting from the first configuration (e.g., row). Upon finding a configuration (e.g., row) where the criterion is fulfilled, the node may apply the configuration (e.g., the configuration on that row). When more than one criterion is associated with one (or more) configurations, in one embodiment, a logical “or” function may be used between the multiple criteria to assess the validity. In another embodiment, a logical “exclusive or” (XOR) function may be used. In another embodiment, a logical “and” function may be used. When more than two criteria are used, it is also possible to use a combination of any of the logical “or,” “exclusive or,” and/or “and” functions.

As used herein, the term “applying” (and similar terms, such as “apply” and “applies”) corresponds to one or more of using, implementing, selecting, activating, or setting (e.g., setting in an active mode). In some embodiments, the configuration information may be applied in an active mode of the node. In some embodiments, the configuration information may be applied in an idle mode of the node.

In some embodiments, the node may use initial configuration information. For example, some radio communication parameters may be “default settings” such that the node may establish initial communication with a network using the default settings. In such embodiments, the initial configuration information may be changed (i.e., different configuration information may be applied) if current information matches at least one criterion, as described elsewhere in this disclosure. In some embodiments, the initial configuration information may be stored in a memory of the node, stored in a SIM in the node, or obtained from the network in communication with the node. It is noted that if the node uses initial configuration information, every possible setting or parameter of the node does not need to be indicated by the initial configuration information.

In some embodiments, the validity criteria includes date and time information. The criteria are compared against current date and time information obtained by the node. The node may obtain date and time information from, for example, the node's own internal clock or from external time references such as servers on the Internet or Global Navigation Satellite System (GNSS). The date and time information may be expressed in terms of Universal Time Coordinated (UTC).

Some embodiments involving date and time information may provide allocation of resources for 3GPP sidelink and vehicle-to-vehicle (V2V) communication based on specific points in time. The configuration may define, e.g., radio resource pools associated with GNSS date and time information to indicate an exact point in time when the resource pools are planned to be used/switched in the future by all nodes.

The configuration may also be a partitioning between two or several spectrum resources to configure: the proportion and/or ratio between them, e.g., in time, frequency, or code domain; hardware resources such as transmitter chains, receiver chains, antennas, or antenna arrays; between resources from two or several Radio Access Technologies (RAT); between different channels, e.g., time slots, frequency bands, codes, or antenna beams; and combinations thereof.

An example of a configuration data structure is illustrated in Table 1 where the first column is the validity criteria in terms of UTC date and time information associated with a configured resource pool in the second column. The node may obtain date and time information, e.g., from a GNSS system, scan the rows of the data structure, and evaluate the obtained date and time information against the validity criteria information. If the criterion is fulfilled, the node may use the corresponding resource pool in the same row until a new criterion is fulfilled.

In the example of Table 1, the resource pool is changed once per year. It means that all nodes that have this data structure change their resource pool configuration in the same manner and at the same time with the time accuracy from GNSS without any signaling connection with controlling cellular network entities, for example.

For the sake of simplicity, Table 1 shows resource pools indicated only with their names or indexes. In some implementations, the rows may contain a detailed configuration of resources, for example, as defined in 3GPP pre-configurations.

TABLE 1

| Date-time (UTC) | Configuration |
|---|---|
| Jan. 1, 2022, 00:00:00 UTC | Resource pool#1 |
| Jan. 1, 2023, 00:00:00 UTC | Resource pool#2 |
| Jan. 1, 2024, 00:00:00 UTC | Resource pool#3 |

Example of planned configuration of resource pools based on UTC

In some embodiments, the validity criteria includes geographical location information. The criteria are compared against current location information obtained by the node. For example, a configuration may be defined for a specific location or country. The node may obtain the current location information from GNSS, or it may be given by the end-user, e.g., in a vehicle.

In Table 2, a resource pool is defined per country. In this example, all nodes that have this data structure change their resource pool configuration in the same manner based on their location without any signaling connection with controlling cellular network entities, for example. Other examples of geographic location information may include a tracking area or tracking area list (for LTE) or a registration area (for 5G).

TABLE 2

| Location | Configuration |
|---|---|
| Japan | Resource pool#1 |
| France | Resource pool#2 |
| United States of America | Resource pool#3 |

### Example of Planned Configuration of Resource Pools Based on Location

In some embodiments, the validity criteria includes the traffic loads of multiple RATs (e.g., LTE sidelink (SL), new radio (NR) SL), which may operate in the same channel or frequency band. The criteria are compared against the traffic load of each RAT estimated by the node. This may apply for a configured measurement period (e.g., a predetermined length of time) and/or a geographical location. Each measurement period may be a relatively long term (e.g., several days, weeks, months) or shorter. For example, different resource pool configurations may be defined based on the ratio of the traffic loads between two RATs using the same channel (or the same frequency band) as shown in Table 3.

The ratio of the traffic loads between two RATs, herein denoted as “RAT a” and “RAT b,” may be computed by dividing the channel busy ratio of “RAT a” with the channel busy ratio of “RAT b.” If the computation is based on averaging over a long time period, all nodes will obtain the same value for the ratio. The configuration table may be constructed to handle different ratios where, e.g., “RAT a” has low traffic load and “RAT b” has high traffic load. This example corresponds to the first row of Table 3. In that case, the ratio of the traffic loads has a low value. The corresponding resource pool configurations for this example use case may provide more resources to “RAT b” than to “RAT a.” It means that the configured resource pool for “RAT b,” denoted as Resource pool #1b, has more resources than the configured resource pool for “RAT a,” denoted as Resource pool #1a.

Another example use case is a situation where the ratio of the traffic loads is balanced between the different RATs and the resource pools may be the same size. This is exemplified in the second row of Table 3, where the resource pools are indexed for “RAT a” and “RAT b” as Resource pool #2a and Resource pool #2b respectively.

Another example use case is a scenario where the traffic load in “RAT b” is higher than that of “RAT a.” This is exemplified in the third row of Table 3, where the resource pools are indexed for “RAT a” and “RAT b” as Resource pool #3a and Resource pool #3b respectively. To account for the higher traffic load on “RAT b” as compared to “RAT a,” Resource pool #3b may have more resources than Resource pool #3a. In this embodiment, common resources may be efficiently shared between different RATs by facilitating adaptation to long-term and/or slow variations of traffic loads between the RATs.

TABLE 3

| The ratio of traffic loads between two RAT's | Configuration |
|---|---|
| 0 ≤ r < 0.3 | Resource pool#1a for RAT a, Resource |
| | pool#1b for RATb |
| 0.3 ≤ r < 0.6 | Resource pool#2a for RAT a, Resource |
| | pool#2b for RAT b |
| 0.6 ≤ r ≤ 1.0 | Resource pool#3a for RAT a, Resource |
| | pool#3b for RATb |

### Example of Planned Configuration of Resource Pools Based on the Ratio of Measured Traffic Loads Between Two RATs

In some embodiments, the validity criteria includes a Channel Busy Ratio (CBR). The criteria are compared against the “long-term” CBR measured by the node. This may apply for a configured measurement period (e.g., a predetermined length of time) and/or a geographical location. The long-term CBR measurement period may be a relatively long term (e.g., several days, weeks, months) or shorter, compared with the measurement period of the existing CBR metric for Release-14/15 LTE SL (100 ms) and Release-16/17 NR SL (100 ms or 100 slots). For example, different resource pool configurations may be defined based on the measured long-term CBR as shown in Table 4.

TABLE 4

| Long-term CBR | Configuration |
|---|---|
| 0 ≤ CBR < 0.3 | Resource pool#1 |
| 0.3 ≤ CBR < 0.6 | Resource pool#2 |
| 0.6 ≤ CBR ≤ 1.0 | Resource pool#3 |

### Example of Planned Configuration of Resource Pools Based on the Long-Term CBR

The validity criteria may include several parameters, e.g., a combination of date and time information, geographical location, traffic loads of RATs, and/or long-term CBR.

In some embodiments, a validity criterion may include some information received by the node. For example, it may be a simple bit (e.g., 0 or 1) received by the node (e.g., from the network). This validity criterion may be received by the node separately from the associated configuration information. In this way, the new configuration may be activated later with little resource overhead. This activation may, for example, use an already existing downlink message, such as network to device.

In some embodiments, a validity criterion may include a specific action performed by the user (e.g., pressing a button, setting-up a call, and/or a data transfer).

In some embodiments, a validity criterion may include not having received transmissions from one of the RATs for a predetermined period of time in the configured resources. This allows a soft transition from one configuration to another configuration in an area where the nodes transition during a period from one configuration version to another.

Any embodiment(s) described in this document may be used as combinations. For example, after a first configuration is valid or planned, a second (new) configuration may be provided with a first validity date and time in the future, and a third configuration may be provided with a (later) second validity date and time in the future. The third configuration may be equivalent to the first configuration. In addition, an additional criterion may be combined with the third configuration, so that the third configuration becomes valid only if the network sends a specific indication to the node (or does not send the indication, in another embodiment). This would allow an automatic “revert to the previous/first configuration” if something goes wrong with the second configuration.

Embodiments in this disclosure are not restricted to the specific examples chosen and may apply on other systems or RATs (for example, 3GPP 6G). The features and results of the disclosure may include configuration of nodes in radio communication and telecommunication systems. It may be used, but not limited to, for vehicle-to-vehicle and vehicle radio and software installed in a vehicle that uses vehicle-to-everything (V2X) radio technologies. Also, techniques in this disclosure may be used for future 3GPP technologies using configuration mechanisms (e.g., 6G V2X).

FIG. 2 is a flowchart of a method 200 for applying configuration information for use in a node, consistent with some embodiments of the present disclosure. The method 200 may be implemented by, for example, node 100 described in connection with FIG. 1.

Current information is determined (step 202). The current information may include any one or more of: date and time information from an internal clock of the node or an external time reference; geographic information about the node from GNSS, for example; traffic load information of a RAT used by the node to communicate with the network; or a CBR measured by the node. In some embodiments where the node is configured to use multiple RATs, the current information may include traffic load information for each of the multiple RATs. While a few specific examples of “current information” have been described above, in some embodiments, the scope of “current information” may include information obtained from or stored in the node, information about another node measured or determined by the node, or information received by the node from the other node or from the network.

One or more sets of criteria and configuration information corresponding to each criterion, stored at the node, are accessed (step 204). The sets may be stored, e.g., in memory 106 of FIG. 1, in any format as described elsewhere in this disclosure, for example, as a table (e.g., one or more of Tables 1, 2, 3, or 4) or similar data structure. The sets may include multiple entries, with each entry including one or more criteria and corresponding configuration information. In some embodiments, the criteria include one or more ranges of values for traffic load information, each criterion corresponding to a respective range of values. In some embodiments, the criteria include one or more ranges of values for the CBR, each criterion corresponding to a respective range of values.

The current information is compared to the one or more sets of criteria (step 206). A determination is made whether the current information matches at least one criterion of the one more sets of criteria (step 208). If the current information matches at least one of the criterion (step 208, “yes” branch), then the configuration information corresponding to the matching criterion is applied by the node (step 210). If the current information does not match any of the criterion (step 208, “no” branch), then the method 200 may iterate, beginning at step 202.

The method 200 may be performed periodically by the node. For example, the method 200 may be performed by the node when the node starts up (i.e., is powered on) or after a predetermined idle period. As another example, the method 200 may be performed during one or more of the following conditions: when current information changes, such as when the date and time information changes (e.g., at 12:00 am on a given day), when the node moves to a different geographic area (e.g., a different cell), or when the measured traffic load information or the channel busy ratio changes by more than a predetermined amount (e.g., more than a threshold amount).

In some embodiments (which may include all the steps of method 200), initial configuration information for the node may be obtained. The node may obtain the initial configuration information from, for example, a network in communication with the node, a memory of the node, or a SIM card in the node. In some embodiments, the initial configuration information may include pre-configuration information as defined in the 3GPP standards, for example. In embodiments involving initial configuration information, the method may include, on a condition that the current information does not match any criterion of the one or more sets of criteria (e.g., based on the determining step 208), applying the initial configuration information in the node.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise,” “include,” or “contain” may be used interchangeably and have the same meaning and are to be construed as inclusive and open-ending. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance, or an example.” By reading this disclosure, including the description of the embodiments and the drawings, it will be appreciated by a person of ordinary skill in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowchart and block diagram in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment,” “some embodiments,” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated to explain the nature of described embodiments may be made by those skilled in the art without departing from the scope of this disclosure. Accordingly, the following claims embrace all such alternatives, modifications, and variations that fall within the terms of the claims.
Clause 1: A method for applying configuration information for use in a node, comprising:
   determining current information;
   accessing, in the node, one or more sets of criteria and configuration information corresponding to each criterion;
   comparing the current information with the one or more sets of criteria; and
   on a condition that the current information matches at least one criterion of the one or more sets of criteria, applying the configuration information corresponding to the matching at least one criterion for use in the node.
Clause 2: The method of clause 1, wherein the node is one of: a network node, a user equipment, or a road side unit.
Clause 3: The method of clause 1, wherein the one or more sets of criteria and configuration information are obtained from a subscriber identity module in the node.
Clause 4: The method of clause 1, wherein the one or more sets of criteria and configuration information are obtained from a network in communication with the node.
Clause 5: The method of clause 1, wherein the configuration information is a pre-configuration.
Clause 6: The method of clause 1, wherein:
   the current information includes date and time information; and
   the criteria include a date and time after which the configuration information is to be applied.
Clause 7: The method of clause 1, wherein the current information includes a current geographic location of the node.
Clause 8: The method of clause 1, wherein the current information includes traffic load information of a radio access technology (RAT) used by the node to communicate with a network.
Clause 9: The method of clause 8, wherein the node is configured to use multiple RATs, and the current information includes traffic load information for each of the multiple RATs.
Clause 10: The method of clause 8, wherein the criteria include one or more ranges of values for the traffic load information, each criterion corresponding to a respective range of values.
Clause 11: The method of clause 1, wherein the current information includes a channel busy ratio measured by the node.
Clause 12: The method of clause 11, wherein the criteria include one or more ranges of values for the channel busy ratio, each criterion corresponding to a respective range of values.
Clause 13: A node for applying configuration information to use in the node, comprising:
   a memory configured to store instructions; and
   a processor configured to execute the instructions stored in the memory to: determine current information;
      access, in the node, one or more sets of criteria and configuration information corresponding to each criterion;
      compare the current information with the one or more sets of criteria; and
      on a condition that the current information matches at least one criterion of the one or more sets of criteria, apply the configuration information corresponding to the matching at least one criterion for use in the node.
Clause 14: The node of clause 13, wherein the node is one of: a network node, a user equipment, or a roadside unit.
Clause 15: The node of clause 13, wherein the one or more sets of criteria and configuration information are obtained from a subscriber identity module in the node.
Clause 16: The node of clause 13, wherein the one or more sets of criteria and configuration information are obtained from a network in communication with the node.
Clause 17: The node of clause 13, wherein the configuration information is a pre-configuration.
Clause 18: The node of clause 13, wherein:
   the current information includes date and time information; and
   the criteria include a date and time after which the configuration information is to be applied.
Clause 19: The node of clause 13, wherein the current information includes a current geographic location of the node.
Clause 20: The node of clause 13, wherein the current information includes traffic load information of a radio access technology (RAT) used by the node to communicate with a network.
Clause 21: The node of clause 20, wherein the node is configured to use multiple RATs, and the current information includes traffic load information for each of the multiple RATs.
Clause 22: The node of clause 20, wherein the criteria include one or more ranges of values for the traffic load information, each criterion corresponding to a respective range of values.
Clause 23: The node of clause 13, wherein the current information includes a channel busy ratio measured by the node.
Clause 24: The node of clause 23, wherein the criteria include one or more ranges of values for the channel busy ratio, each criterion corresponding to a respective range of values.
Clause 25: A non-transitory computer-readable medium storing instructions that are executable by one or more processors of a node in a communication network to perform a method, the method comprising:
   determining current information;
   accessing, in the node, one or more sets of criteria and configuration information corresponding to each criterion;
   comparing the current information with the one or more sets of criteria; and
   on a condition that the current information matches at least one criterion of the one or more sets of criteria, applying the configuration information corresponding to the matching at least one criterion for use in the node.

1. A method for communication by a UE comprising;
obtaining at least one set of time information and configuration information for synchronization resources from a network node in communication with the UE, wherein the time information indicates time after which the configuration information is to be used, and
performing synchronization using the configuration information for the synchronization resources in case that current time is after the time indicated by the time information.

2. A method according to claim 1,
wherein the configuration information is for non-terrestrial communication.

3. A method according to claim 1,
wherein the configuration information is information for synchronization with at least one node.

4. A method according to claim 3,
wherein the at least one node is a target satellite.

5. A method according to claim 1,
wherein the configuration information is set with geographic area information, and
using the configuration information in case that the UE is further located in the range that is indicated by the geographic area information.

6. A method according to claim 1,
wherein the configuration information is different from a configuration information that is used current communication and indicates a configuration information that is necessary for next communication.

7. A method according to claim 1,
further starting using the configuration information when the current time is just after the time indicated by the time information.

8. A UE comprising a controller comprising at least one processor configured to perform;
obtaining at least one set of time information and configuration information for synchronization resources from a network node in communication with the UE, wherein the time information indicates time after which the configuration information is to be used, and
performing synchronization using the configuration information for the synchronization resources in case that current time is after the time indicated by the time information.

9. A UE according to the claim 8,
wherein the configuration information is for non-terrestrial communication.

10. A UE according to the claim 8,
wherein the configuration information is information for synchronization with at least one node.

11. A UE according to the claim 10,
wherein the at least one node is a target satellite.

12. A UE according to the claim 8,
wherein the configuration information is set with geographic area information, and using the configuration information in case that the UE is further located in the range that is indicated by the geographic area information.

13. A UE according to claim 8,
wherein the configuration information is different from a configuration information that is used current communication and indicates a configuration information that is necessary for next communication.

14. A UE according to claim 8,
further starting using the configuration information when the current time is just after the time indicated by the time information.

15. A non-transitory computer-readable medium storing instructions that are executable by one or more processors of a node in a communication network to perform a method, the method comprising:
obtaining at least one set of time information and configuration information for synchronization resources from a network node in communication with the UE, wherein the time information indicates time after which the configuration information is to be used, and
performing synchronization using the configuration information for the synchronization resources in case that current time is after the time indicated by the time information.

16. A non-transitory computer-readable medium according to claim 15,
wherein the configuration information is for non-terrestrial communication.

17. A non-transitory computer-readable medium according to claim 15,
wherein the configuration information is information for synchronization with at least one node.

18. A non-transitory computer-readable medium according to claim 17,
wherein the at least one node is a target satellite.

19. A non-transitory computer-readable medium according to claim 15,
wherein the configuration information is set with geographic area information, and
using the configuration information in case that the UE is further located in the range that is indicated by the geographic area information.

20. A non-transitory computer-readable medium according to claim 15,
wherein the configuration information is different from a configuration information that is used current communication and indicates a configuration information that is necessary for next communication.
